(19) United States
(12) Patent Application Publication
(10) Pub. No.: US 2026/0186815 A1
(43) Pub. Date: Jul. 2, 2026

(54) MEMORY MANAGEMENT BY A VIRTUAL MACHINE MANAGER

(71) Applicant: Google LLC, Mountain View, CA (US)

(72) Inventors: Idan Barda Raiter, Glendale, CA (US); Judson Powers, Ithaca, NY (US); Steven Aaron Richman, San Francisco, CA (US); Oystein Eftevaag, San Francisco, CA (US)

(21) Appl. No.: 19/005,791

(22) Filed: Dec. 30, 2024

(51) Int. Cl. G06F 9/455

(52) U.S. Cl. CPC G06F 9/45558; G06F 9/45545; G06F 2009/45583

(57) ABSTRACT

An example method includes receiving, by a host operating system (OS), a first request to allocate memory pages in host virtual memory. In response, the host OS allocates a first guest memory region of host virtual memory to a virtual machine by at least pinning the first guest memory region. The method further includes receiving, by the host OS, a second and a third request to allocate memory pages. In response, the host OS allocates a second and third guest memory region to the virtual machine. The second guest memory region overlaps a first sub-region of the first guest memory region and the third guest memory region overlaps a second sub-region of the first guest memory region. The method further includes unpinning, by the host OS, a third sub-region of the first guest memory region, the third sub-region overlapping neither the first sub-region nor the second sub-region.

### BACKGROUND

A host operating system may execute one or more virtual machines (VMs), each with independent operating systems and functionality. VMs may be a software-based “virtual” version of a computing device with dedicated amounts of host computing system processor, memory, and storage resources. A VM manager may facilitate memory transactions between the host operating system and the VMs.

### SUMMARY

In general, techniques of this disclosure are directed to memory management by virtual machine managers. An example virtual machine manager may be a type 2 hypervisor. The hypervisor may perform a memory splitting process by first transmitting a function call to a host operating system (OS) using an application programming interface. The function call may include a request to allocate memory pages in host virtual memory. In response, the host OS may allocate a first guest memory region in a host memory region by, in part, locking the first guest memory region. The hypervisor may then transmit a pair of function calls to the host OS to have the host OS allocate a second and a third guest region overlapping the first region. Finally, the hypervisor may transmit another function call to have the host OS deallocate the first guest region. Because the host OS locks and unlocks memory regions based on reference counts, and the reference count for the pertinent regions does not drop to zero during the memory splitting process, the host OS does not unlock the pertinent memory regions during the memory splitting process. The memory splitting process therefore enables the hypervisor to hole punch in host memory while avoiding race issues associated with memory management for multiple entities.

The hypervisor may also implement a dynamic fragmentation size during memory operations. In some implementations, the host OS may use techniques of this disclosure to pin memory regions according to a fragmentation alignment, reducing work for subsequent memory accesses. For example, the host OS may pin a memory region between two fragmentation alignment points in response to receiving a memory access request. Further, the hypervisor may use an accelerated data structure of memory regions to maintain the pinned memory regions in host memory. The accelerated data structure may be, for example, an AVL tree or skip list. For instance, the hypervisor may maintain an AVL tree of guest memory addresses in host memory.

In one example, the disclosure is directed toward a method that includes receiving, by a host operating system via a function call, a first request to allocate memory pages in host virtual memory. The method further includes, responsive to receiving the first request, allocating, by the host operating system, a first guest memory region of host virtual memory to a virtual machine by at least pinning the first guest memory region. The method also includes receiving, by the host operating system via one or more subsequent function calls, a second request and a third request to allocate memory pages in the host virtual memory. The method additionally includes, responsive to receiving the one or more subsequent function calls, allocating, by the host operating system, a second guest memory region of the host virtual memory to the virtual machine and a third guest memory region of the host virtual memory to the virtual machine. The second guest memory region overlaps a first sub-region of the first guest memory region and the third guest memory region overlaps a second sub-region of the first guest memory region. The method also includes unpinning, by the host operating system, a third sub-region of the first guest memory region, the third sub-region overlapping neither the first sub-region nor the second sub-region.

In another example, the disclosure is directed toward a computing system comprising one or more processors, and one or more storage devices that store instructions. The instructions, when executed by the one or more processors, cause the one or more processors to receive, via a function call, a first request to allocate memory pages in host virtual memory. The instructions further cause the one or more processors to, responsive to receiving the first request, allocate a first guest memory region of host virtual memory to a virtual machine by at least pinning the first guest memory region. The instructions additionally cause the one or more processors to receive, via one or more subsequent function calls, a second request and a third request to allocate memory pages in the host virtual memory. The instructions also cause the one or more processors to, responsive to receiving the one or more subsequent function calls, allocate a second guest memory region of the host virtual memory to the virtual machine and a third guest memory region of the host virtual memory to the virtual machine. The second guest memory region overlaps a first sub-region of the first guest memory region and the third guest memory region overlaps a second sub-region of the first guest memory region. The instructions further cause the one or more processors to unpin a third sub-region of the first guest memory region, the third sub-region overlapping neither the first sub-region nor the second sub-region.

In another example, the disclosure is directed toward a non-transitory computer-readable storage medium encoded with instructions that, when executed by one or more processors, cause one or more processors to receive, via a function call, a first request to allocate memory pages in host virtual memory. The instructions further cause the one or more processors to, responsive to receiving the first request, allocate a first guest memory region of host virtual memory to a virtual machine by at least pinning the first guest memory region. The instructions also cause the one or more processors to receive, via one or more subsequent function calls, a second request and a third request to allocate memory pages in the host virtual memory. The instructions additionally cause the one or more processors to, responsive to receiving the one or more subsequent function calls, allocate a second guest memory region of the host virtual memory to the virtual machine and a third guest memory region of the host virtual memory to the virtual machine. The second guest memory region overlaps a first sub-region of the first guest memory region and the third guest memory region overlaps a second sub-region of the first guest memory region. The instructions further cause the one or more processors to unpin a third sub-region of the first guest memory region, the third sub-region overlapping neither the first sub-region nor the second sub-region.

In another example, the disclosure is directed toward a computer program product for generating custom user interfaces for performing tasks associated with background applications. The computer program product comprises one or more instructions that, when executed by at least one processor, cause the at least one processor to receive, via a function call, a first request to allocate memory pages in host virtual memory. The one or more instructions further cause the at least one processor to, responsive to receiving the first request, allocate a first guest memory region of host virtual memory to a virtual machine by at least pinning the first guest memory region. The one or more instructions further cause the at least one processor to receive, via one or more subsequent function calls, a second request and a third request to allocate memory pages in the host virtual memory. The one or more instructions further cause the at least one processor to, responsive to receiving the one or more subsequent function calls, allocate a second guest memory region of the host virtual memory to the virtual machine and a third guest memory region of the host virtual memory to the virtual machine. The second guest memory region overlaps a first sub-region of the first guest memory region and the third guest memory region overlaps a second sub-region of the first guest memory region. The one or more instructions further cause the at least one processor to unpin a third sub-region of the first guest memory region, the third sub-region overlapping neither the first sub-region nor the second sub-region.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example host computing system for managing virtual machines, in accordance with one or more techniques of this disclosure.

FIG. 2 is a conceptual diagram illustrating an example host virtual memory space, in accordance with one or more techniques of this disclosure.

FIG. 3 is a conceptual diagram illustrating example memory regions in host virtual memory and corresponding memory regions in guest physical memory, in accordance with one or more techniques of this disclosure.

FIG. 4A is a conceptual diagram illustrating techniques for pinning memory in host virtual memory on demand, in accordance with one or more techniques of this disclosure.

FIG. 4B is a conceptual diagram illustrating techniques for pinning memory in host virtual memory via a fragmentation size, in accordance with one or more techniques of this disclosure.

FIG. 5 is a conceptual diagram illustrating techniques for pinning memory in a first region state according to fragmentation alignment points, in accordance with one or more techniques of this disclosure.

FIG. 6 is a conceptual diagram illustrating techniques for pinning memory in a second region state according to fragmentation alignment points, in accordance with one or more techniques of this disclosure.

FIG. 7 is a flowchart illustrating an example operation for memory management by a host operating system, in accordance with one or more techniques of this disclosure.

### DETAILED DESCRIPTION

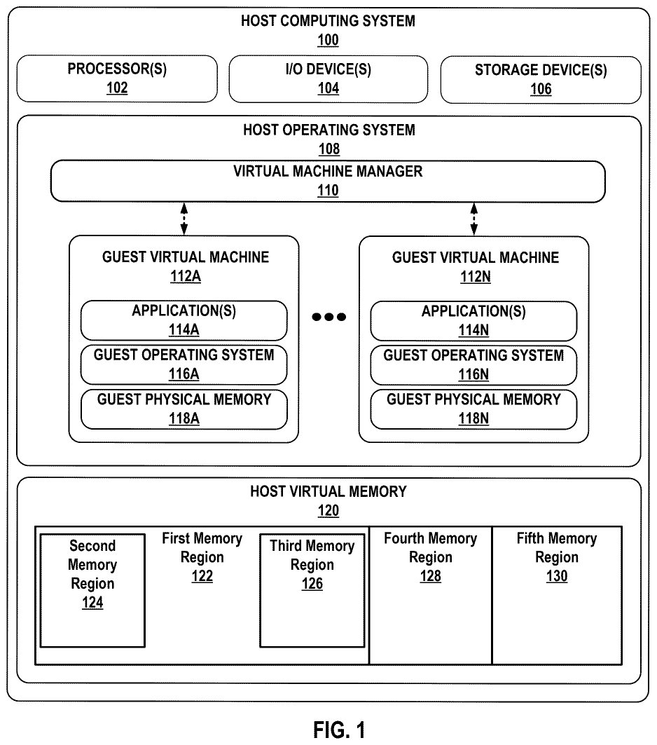

FIG. 1 is a conceptual diagram illustrating an example host computing system 100 for managing virtual machines (VMs), in accordance with one or more techniques of this disclosure. Host computing system 100 may by any computing system capable of hosting VMs, e.g. one or more desktop computers, laptop computers, mainframes, servers, mobile devices, wearable devices, cloud computing systems, software-defined vehicles (SDVs), vehicle computing systems, automotive head units (e.g., infotainment systems), and/or digital instrument clusters. Host computing system 100 may include various components, e.g. one or more processors 102, one or more input/output (I/O) devices 104, one or more storage devices 106, and host virtual memory 120. In some examples, the components of host computing system 100 may reside and execute on the same or separate computing devices and systems operated by and/or under the control of one or more entities.

Processors 102 may implement functionality and/or execute instructions within host computing system 100. For example, processors 102 may receive and execute instructions stored by storage devices 106. The instructions may enable various functionalities of components e.g. host operating system (OS) 108, VM manager (VMM) 110, and guest VMs 112. The instructions may direct host computing system 100 to store and/or modify information within storage devices 106 during program execution. Further, processors 102 may execute instructions of host OS 108, VMM 110, and guest VMs 112. For instance, processors 102 may operate host OS 108, VMM 110, and guest VMs 112 to perform various techniques described herein. Processors 102 may include one or more central processing units (CPUs), graphics processing units (GPUs), application processors (APs), and/or any other processor configured to perform operations via an instruction set.

I/O devices 104 may receive input and/or provide output. I/O devices 104 may include, for example, keyboards, microphones, speakers, video displays (e.g., organic light emitting diode displays (OLEDs) and liquid crystal displays (LCDs)), or any other device for receiving input or providing output. Host computing system 100 may store input received by I/O devices 104 in memory, e.g. host virtual memory 120.

Storage devices 106 may store information during operation of host computing system 100. For example, storage devices 106 may store data associated with host OS 108, VMM 110, and/or guest VMs 112. In some implementations, storage devices 106 may include one or more hard disk drives, solid-state drives, hybrid drives, removable media drives, optical drives, and/or any other device configured to store information. Storage devices 106 may be configured for short-term storage of information as volatile memory and therefore may not retain stored contents if powered off. Examples of volatile memories include random access memory (RAM), dynamic random-access memory (DRAM), and static random-access memory (SRAM).

Host computing system 100 executes host OS 108, host OS 108 including VMM 110 and guest VMs 112. Host OS 108 may perform operations described herein using software, hardware, firmware, or a mixture of hardware, software, and firmware residing in and/or executing at host computing system 100. In some implementations, host computing system 100 may execute host OS 108, VMM 110, and/or guest VMs 112 as one or more executable programs at an application layer of host computing system 100.

Host OS 108 manages hardware resources and provides a platform for software execution at host computing system 100. Host OS 108 may perform scheduling algorithms (e.g., round-robin and multilevel queues), allocate memory via virtual memory management and paging mechanisms, and/or facilitate interprocess communication (IPC) via message queues, pipes, and shared memory. Host OS 108 may implement preemptive multitasking, real-time scheduling for deterministic latency, and dynamic power management to improve performance and power consumption of host computing system 100.

Host OS 108 may be a host OS for VMM 110 and guest VMs 112. For example, host OS 108 may provide services and resources to VMM 110 and guest VMs 112, including hardware abstraction and access services, resource management services, file system services, networking services, device emulation services, security and isolation services, power and thermal management services, and/or debugging and monitoring services. For instance, host OS 108 may use processor scheduling techniques to provide processing resources to guest VMs 112.

VMM 110 enables the creation, management, and execution of VMs by acting as an intermediary layer between host computing system 100 and guest VMs 112. VMM 110 may be a low-level virtualization layer (e.g., a hypervisor) that abstracts physical hardware resources of host computing system 100 and provides each VM of guest VMs 112 with a virtualized hardware environment, enabling multiple isolated operating systems to run concurrently on host computing system 100. In some implementations, VMM 110 may perform CPU scheduling, memory management (including page table virtualization and nested paging), and I/O device emulation or paravirtualization to improve performance of host computing system 100 and/or guest VMs 112.

Each guest VM of guest VMs 112 may be an isolated software-based environment that emulates a physical computer system. Guest VMs 112 may include virtualized components, e.g. CPUs, memory (e.g., guest physical memory 118), storage, and network interfaces. Further, each guest VM of guest VMs 112 may execute one or more applications 114 and guest OS 116 via the virtualized components. For example, guest VM 112A may execute a first OS, a gaming application, and a weather application, while guest VM 112N executes a second OS and a navigation application.

Applications 114 may be first-party, second-party, or third-party applications of guest VMs 112. Applications 114 may extend software functionality of guest VMs 112, where applications 114 may execute within an execution environment presented by guest OS 116 and/or guest VMs 112. Applications 114 may, as a few examples, provide gaming services (e.g., video games), email services, web browsing services, texting and/or chat services, web conferencing services, video conferencing services, music services (including streaming music services), video services (including video streaming services), navigation services, weather services, word processing services, spreadsheet services, slide and/or presentation services, assistant services, text entry services, network access services, or any other application service.

Each guest VM of guest VMs 112 includes guest physical memory 118. Although, in some implementations, guest physical memory 118 is a virtualized component of guest VMs 112, guest VMs 112 may perceive guest physical memory 118 as a physical component due to abstractions provided by VMM 110 to simulate physical memory for guest VMs 112. VMM 110 may map guest physical memory 118 to either host physical memory (e.g., real RAM) or host virtual memory 120 managed by host OS 108. VMM 110 may use a data structure, e.g. a memory descriptor list (MDL), to initiate and/or store the mapping of guest physical memory regions to other memory regions of host computing system 100.

Host computing system 100 also includes host virtual memory 120. Host virtual memory 120 may be a system-wide memory abstraction that uses memory and storage of host computing system 100 to fulfill memory requests of VMM 110 and guest VMs 112. For instance, host virtual memory 120 may be a portion of physical memory (e.g., RAM) and/or storage devices 106 (e.g., swap space) available for use by VMM 110 and guest VMs 112. In some implementations, host virtual memory 120 may back all or part of guest physical memory 118.

Host virtual memory 120 may back all or part of guest physical memory 118 via memory region correspondence. For instance, memory regions of host virtual memory 120 may correspond with memory regions of guest physical memory 118 based on instructions provided by VMM 110. Host OS 108 may use data structures e.g. MDLs to orchestrate the memory region correspondence. For example, guest VM 112A may request a one gigabyte (GB) memory region as if guest VM 112A is allocating physical memory. Guest VM 112A may plan to use the requested memory for running processes, e.g. gaming services.

After receiving the request for one GB of memory, VMM 110 may request that host OS 108 allocate a one GB region in host virtual memory 120. To initiate the request, VMM 110 may call a kernel-mode application programming interface (API) via a function call, the API returning an MDL describing the mapping of a virtual address range to underlying physical pages. The MDL, generated by host OS 108 and returned to VMM 110 responsive to the function call, may describe a contiguous region of host virtual memory 120 for the one GB allocation (e.g., first memory region 122), and corresponding physical pages in host memory or pages that may be swapped to storage devices 106. VMM 110 may then map a region of guest physical memory 118A to the region in host virtual memory 120 described by the MDL. In some implementations, VMM 110 may use a mapping table to correlate guest physical addresses to host virtual addresses. When guest VM 112A accesses a memory address within a mapped range, VMM 110 may facilitate the memory access by translating the guest physical memory address to the corresponding host virtual memory 120 address via the mapping table.

Host OS 108 may implement pinning techniques to stabilize allocated memory regions of host virtual memory 120. In some aspects, host OS 108 may page memory in host virtual memory 120 by swapping contents of host virtual memory 120 to disk or relocating the contents in physical memory. When host OS 108 allocates regions in host virtual memory 120 to guest VMs 112, host OS 108 may pin the allocated region in host virtual memory 120 to prevent the region from being swapped while in use by guest VMs 112. For instance, host OS 108 may set flags or initiate API calls to lock the memory pages within the allocated regions, keeping the regions from being paged out or reallocated. Host OS 108 may later unpin the region in response to an indication by VMM 110 that the region may be unpinned.

In some implementations, reference counters associated with memory addresses (e.g., page addresses) of host virtual memory 120 may indicate whether the respective memory address is allocated to a VM. Host OS 108 may pin and/or unpin regions of host virtual memory 120 based on the reference counters. For example, a memory address having a reference counter value of zero may be placed in an unlocked state, while values above zero may be placed in a locked state. Host OS 108 may allocate first memory region 122 by, in part, incrementing, from zero to one, reference counters associated with the memory addresses of first memory region 122. Host OS 108 may then allocate second memory region 124 and third memory region 126 by again incrementing the reference counters associated with the memory addresses of second memory region 124 and third memory region 126. The memory addresses of second memory region 124 and third memory region 126 were already in a locked state, but now have a reference counter value of two. Similarly, host OS 108 may deallocate addresses of host virtual memory 120 by, in part, decrementing reference counters. Once a reference counter for an address reaches zero, the address may be placed in an unlocked state where it may be swapped by host OS 108 and/or allocated to a different VM.

In accordance with techniques of the disclosure, host OS 108 may receive, via a function call, a first request to allocate memory pages in host virtual memory 120. For example, VMM 110 may provide the first request to host OS 108 based on memory use indications from guest VM 112A. The first request may specify a region of host virtual memory 120 to be allocated and/or pinned by host OS 108. The first request to allocate memory pages, and any subsequent requests to allocate memory pages, may be a request that host OS 108 allocate and/or pin a range of host virtual memory 120 for use by guest VM 112A.

Responsive to receiving the first request, host OS 108 may allocate a first guest memory region of host virtual memory 120 to a VM by at least pinning the first guest memory region. In the example shown with respect to FIG. 1, the first guest memory region may be first memory region 122, and host virtual memory 120 may include other memory regions, e.g. fourth memory region 128 and fifth memory region 130. Host OS 108 may allocate first memory region 122 to a guest VM, e.g. guest VM 112A. Further, host OS 108 may pin first memory region 122 by placing it in a locked state. Pinning first memory region 122 may include incrementing a reference counter associated with the memory addresses of first memory region 122. After host OS 108 pins first memory region 122, fourth memory region 128 and fifth memory region 130 may be in an unpinned state or may be pinned and allocated to a guest VM of guest VMs 112.

Host OS 108 may receive, via one or more subsequent function calls, a second request and a third request to allocate memory pages in host virtual memory 120. The second request and third request may specify sub-regions of first memory region 122 to be allocated. For instance, if the first request to allocate memory pages specifies addresses 100-200 of memory, the second request may specify addresses 110-140 and the third request may specify addresses 160-170.

In response to receiving the one or more subsequent function calls, host OS 108 may allocate a second guest memory region of host virtual memory 120 to a VM and a third guest memory region of host virtual memory 120 to the VM. The second guest memory region may overlap a first sub-region of the first guest memory region. Further, the third guest memory region may overlap a second sub-region of the first guest memory region. For instance, the one or more subsequent function calls may request second memory region 124 and third memory region 126 of host virtual memory 120.

As discussed, allocating the second guest memory region and the third guest memory region to the guest VM may not include transitioning memory of host virtual memory 120 from an unpinned state to a pinned state. For example, if the second guest memory region only includes addresses already included by the allocated first guest memory region, then the addresses of the second guest memory region may already be in a pinned state prior to allocating the second guest memory region. Further, host OS 108 may increment a reference counter associated with the region of host virtual memory 120 to be allocated. For instance, host OS 108 may increment one or more reference counters associated with second memory region 124 and/or third memory region 126 responsive to allocating the memory regions to a guest VM.

As shown with respect to FIG. 1, second memory region 124 and third memory region 126 may overlap sub-regions of first memory region 122. For example, second memory region 124 may share memory addresses of host virtual memory 120 with first memory region 122. Similarly, third memory region 126 may share memory addresses of host virtual memory 120 with first memory region 122. In some implementations, second memory region 124 and/or third memory region 126 may overlap sub-regions of first memory region 122 while also extending outside of first memory region 122. For instance, first memory region 122 may be addresses 100-200 of host virtual memory 120, and second memory region 124 may be addresses 90-110 of host virtual memory 120.

Host OS 108 may unpin a third sub-region of the first guest memory region, the third sub-region overlapping neither the first sub-region nor the second sub-region. For example, the third sub-region may include all memory addresses of first memory region 122 that are outside of second memory region 124 and third memory region 126. After allocating second memory region 124 and third memory region 126 to a guest VM, host OS 108 may deallocate first memory region 122 by, in part, decrementing reference counters of first memory region 122. Second memory region 124 and third memory region 126, having reference counter values above zero (e.g., one), may remain in a pinned state. Pages outside of second memory region 124 and third memory region 126 (e.g., in the third sub-region), may have reference counter values of zero and may therefore be placed in an unpinned state.

By allocating a second and third memory region in host virtual memory 120 prior to deallocating a first memory region, host OS 108 ensures that the second and third memory region remain in a pinned state while freeing unneeded memory of the first memory region. Various techniques of this disclosure for managing memory may therefore be implemented to dynamically hole punch larger memory regions into smaller memory regions. Dynamic hole-punching enables host computing system 100 to deallocate unused memory regions of a VM without stopping the VM or host OS 108, thereby improving the memory management capabilities of host computing system 100 as compared to other computing systems. Furthermore, VMM 110 may implement the techniques for managing memory using only a limited API, e.g., an API that only enables VMM 110 to request regions of host virtual memory 120 on behalf of guest VMs 112.

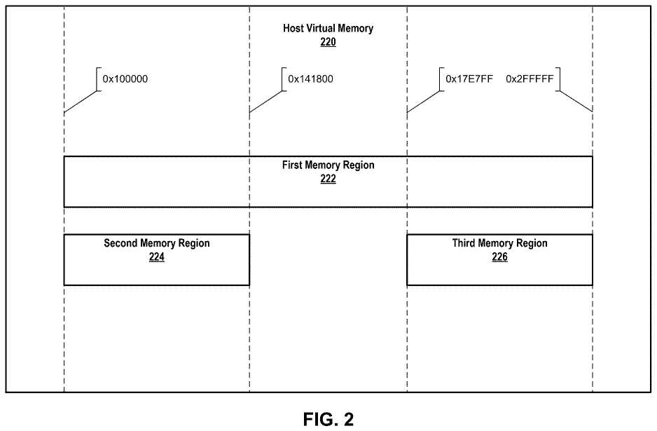

FIG. 2 is a conceptual diagram illustrating an example host virtual memory space, in accordance with one or more techniques of this disclosure. As shown in FIG. 2, host virtual memory 220 includes first memory region 222. In some examples, a guest VM, e.g. guest VM 112A, indicates a specified amount of requested memory to VMM 110. VMM 110 then transmits a request to host OS 108 based on the requested memory. The request may be a request that host OS 108 allocates and/or pins a range of memory in host virtual memory 220. For instance, the request may be for host OS 108 to allocate a two megabyte (MB) portion of memory in host virtual memory 220.

Host OS 108 may perform one or more steps to allocate the portion of memory in host virtual memory 220. Host OS 108 may first reserve a contiguous two MB range (e.g., first memory region 222) in host virtual memory 220, represented by a virtual memory area (VMA) structure in a memory management system of host OS 108. In the example illustrated with respect to FIG. 2, first memory region 222 occupies memory addresses 0x100000 through 0x2FFFFF, where each address is associated with a base unit of memory (e.g., a page).

Host OS 108 may then create page table entries (PTEs) for first memory region 222. Initially, each page may not be backed by hardware, depending on the memory allocation strategy of host OS 108. For example, if host OS 108 implements lazy allocation, the pages may only be backed by host physical memory when VMM 110 or a guest VM accesses first memory region 222. If host OS 108 implements immediate allocation, host OS 108 may immediately commit physical memory pages from memory hardware for first memory region 222. Host OS 108 may then pin first memory region 222 to ensure that the pages of first memory region 222 are not swapped. Additionally, host OS 108 may generate an MDL to describe the mapping of first memory region 222 to corresponding host physical memory pages.

Once first memory region 222 has been allocated, host OS 108 may return the MDL and/or one or more base virtual addresses of first memory region 222 to VMM 110. VMM 110 may generate a mapping of the guest VM's physical memory to the allocated host virtual memory returned by host OS 108. The mapping may be stored in an internal data structure of VMM 110 for translation during VM execution. For example, VMM 110 may generate an accelerated structure of memory regions. The accelerated structure may be a data structure e.g. a tree, skip list, or linked list and may include one or more addresses of a set of guest memory regions in host virtual memory 220. For instance, the accelerated structure may be an AVL tree sorting each node according to a memory region's starting address. VMM 110 may then determine guest memory region locations based on the accelerated structure of memory regions.

VMM 110 may provide additional requests for memory to host OS 108. For example, VMM 110 may determine that a guest VM is not using a portion of first memory region 222 or that first memory region 222 should otherwise be reduced in size. VMM 110 may then transmit requests for memory to host OS 108. The requests for memory may indicate second memory region 224 (e.g., addresses 0x100000 through 0x141800) and third memory region 226 (e.g., addresses 0x17E7FF through 0x2FFFFF).

Responsive to receiving the requests for memory, host OS 108 may allocate and/or pin additional memory regions indicated by the requests. For example, host OS 108 may allocate second memory region 224 and third memory region 226 for VMM 110 and/or a guest VM. After receiving the requests for memory, host OS 108 may receive an additional request from VMM 110, the additional request being to deallocate first memory region 222.

In response to receiving the additional request, host OS 108 may unpin a sub-region of first memory region 222. For example, host OS 108 may deallocate first memory region 222, including unpinning any unallocated portions of memory. In this example, second memory region 224 (e.g., addresses 0x100000 through 0x141800) and third memory region 226 (e.g., addresses 0x17E7FF through 0x2FFFFF) are allocated and therefore may remain pinned. Host OS 108 may unpin a sub-region of first memory region 222 (e.g., 0x141800 through 0x17E7FF) because the sub-region is no longer allocated. Additionally, or alternatively, host OS 108 may unpin the sub-region in response to receiving an unpin request from VMM 110, the unpin request indicating the sub-region.

As discussed, requests to allocate memory may be from VMM 110, where VMM 110 may be a component of host OS 108 but not a component of a guest VM of guest VMs 112. For example, VMM 110 may be a type 2 hypervisor. In some implementations, VMM 110 may additionally or alternatively be a component of a VM. For example, VMM 110 may be a memory manager of a VM.

As discussed, host OS 108 may generate an MDL. The MDL may include a virtual address range and a physical address range corresponding to the virtual address range, wherein allocating a host virtual memory region (e.g., first memory region 222) is based on the virtual address range. For instance, the virtual address range may be 0x100000 through 0x2FFFFF of host virtual memory 220 and the physical address range may be 0x400000-0x5FFFFF of guest physical memory 118A. The MDL may include additional memory management information, e.g. a length of a memory region, page frame numbers, number of pages represented by the MDL, and/or flags (e.g., whether the region is pinned). Host OS 108 may transmit the MDL to VMM 110 in response to receiving a function call. For example, host OS 108 may return the MDL to VMM 110 in response to receiving a request to allocate and/or pin memory via a function call.

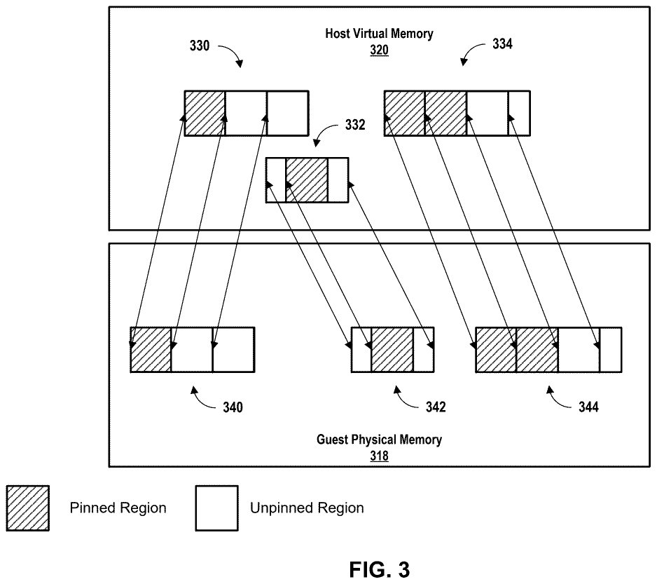

FIG. 3 is a conceptual diagram illustrating example memory regions in host virtual memory and corresponding memory regions in guest physical memory, in accordance with one or more techniques of this disclosure. As shown in FIG. 3, host virtual memory 320 includes first virtual memory region 330, second virtual memory region 332, and third virtual memory region 334. Guest physical memory 318 includes first physical memory region 340, second physical memory region 342, and third physical memory region 344. First virtual memory region 330 corresponds to first physical memory region 340. Second virtual memory region 332 corresponds to second physical memory region 342. Third virtual memory region 334 corresponds to third physical memory region 344.

Memory operations in guest physical memory 318 may affect corresponding memory regions in host virtual memory 320. For example, if a VM writes information to first physical memory region 340, a host component (e.g. VMM 110 or host OS 108) may write the information to first virtual memory region 330. The host component may translate guest physical memory operations via an accelerated structure of memory regions. For instance, VMM 110 may store an AVL tree, the AVL tree mapping guest physical memory addresses to host virtual memory addresses.

In some implementations, a host OS may pin memory in response to memory operations by a guest VM, rather than pinning the memory as a part of a memory allocation process. For example, host OS 108 may allocate first virtual memory region 330 for a guest VM without pinning first virtual memory region 330 in host virtual memory 320. Host OS 108 may pin portions of first virtual memory 330 as the portions are accessed by VMM 110 on behalf of a guest VM. As shown in FIG. 3, some portions of memory regions may be pinned and some portions may be unpinned depending on memory transactions conducted by a guest VM. The accelerated structure of memory regions may store beginning addresses of each portion of memory regions for both host virtual memory 320 and guest physical memory 318.

As discussed, various aspects of the present disclosure are directed to VMMs, e.g. hypervisors. Type 1 hypervisors host operating systems and execute on bare metal. Type 2 hypervisors may execute as a component of a host OS (e.g., host OS 108). Various aspects of the present disclosure are directed to type two hypervisors. In some examples, the type two hypervisor is a kernel driver that interfaces with an OS kernel in a delicate way. The hypervisor should not break any functionality of the host kernel while, at the same time, handling context switches in and out of VMs.

Memory management is especially prone to breaking host kernel functionality. When a VM requests to use memory, a type two hypervisor asks the host OS to pin the memory. Otherwise, the host OS may believe the memory may be moved around freely. In fact, the memory should not be moved while a VM is executing. In the context of type two hypervisors, pinned memory is unreclaimable to the host OS. If a computing device implements a type two hypervisor, techniques should be implemented to avoid starving the host OS of memory. These techniques often include using primitives in the host kernel to make pinning and unpinning more efficient. Various aspects of the present disclosure are directed to techniques for making memory pinning and unpinning more efficient, and to techniques for avoiding starving the host OS of resources.

In some implementations, a host OS is configured to receive a system call to pin memory. The system call may be titled, for example, MmProbeAndLockPages. The system call may take a desired range of memory to pin and return an MDL, the MDL being a handle for later unpinning the same region. Some hypervisors configured to receive MmProbeAndLockPages may not be configured to split memory regions via a dedicated system call. However, splitting memory regions may be achieved via a technique including first pinning an old MDL sometime earlier, pinning two new MDLs overlapping the old MDL, and unpinning the old MDL. The effect of the technique is that the new region(s) of memory take hold without un-pinning any pages of the new regions, resulting in an atomic hole-punch. One of the new MDLs may then be freed (e.g., the region may be unpinned) to effectively remove part of the old MDL (e.g., the old region).

Because memory locking may be reference counted, it is possible to split one MDL into two by pinning desired MDLs in the same range first and then unpinning the old MDL. Various aspects of the present disclosure convert an API for locking memory ranges into a freeform API for mapping and unmapping parts of memory for a guest VM via splitting techniques. Further, a memory manager component may maintain an accelerated structure of memory regions (e.g., skip list and/or AVL tree), and is able to, on demand, hole punch through regions that a user wants to remove. These techniques enable hypervisors to support high velocity map and unmap requests and region-splitting capabilities. In some implementations, security measures are implemented to make sure memory has not shifted in between requests. For example, the virtual to physical memory mapping of a user space may not be fixed, so some aspects include verifying that the mapping has not changed when a split is requested.

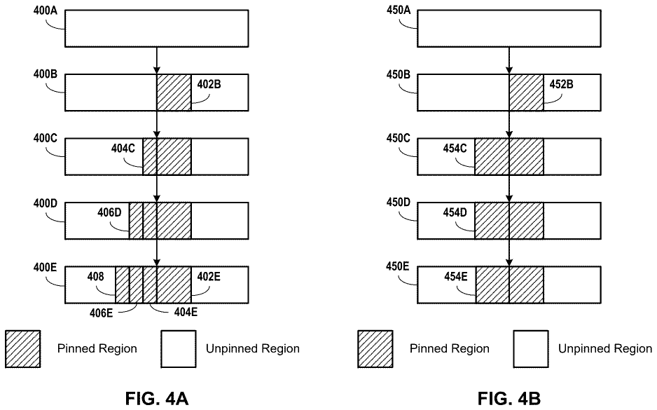

FIG. 4A is a conceptual diagram illustrating techniques for pinning memory in host virtual memory on demand, in accordance with one or more techniques of this disclosure. Memory regions 400 may represent a region of host virtual memory, e.g. first memory region 122. As shown in FIG. 4A, memory regions 400 may illustrate the region of host virtual memory after various memory operations. For example, memory region 400A may be a host virtual memory region before a memory operation, memory region 400B may be the host virtual memory region after a first operation, memory region 400C may be the host virtual memory region after a second operation, memory region 400D may be the host virtual memory region after a third operation, and memory region 400E may be the host virtual memory region after a fourth operation.

In FIG. 4A, a host OS (e.g., host OS 108) pins memory on demand. For example, each time host OS 108 receives a request to allocate memory in a memory region, host OS 108 pins an amount of memory indicated by the request. As shown, memory region 400A includes only unpinned memory. For example, memory region 400A may include two MB of memory pages, where each page is in an unlocked state. Memory region 400B may be memory region 400A after host OS 108 pins sub-region 402B. For example, host OS 108 may receive a request to allocate memory in memory region 400A, and, responsive to the request, host OS 108 may pin sub-region 402B. Sub-region 402B may match a size or a memory range indicated by the request to allocate memory in memory region 400A. Memory region 400C may be memory region 400B after host OS 108 pins sub-region 404C. For example, host OS 108 may receive a request to allocate memory in memory region 400B, and, responsive to the request, host OS 108 may pin sub-region 404C. Sub-region 404C may match a size or a memory range indicated by the request to allocate memory in memory region 400B.

Memory region 400D may be memory region 400C after host OS 108 pins sub-region 406D. For example, host OS 108 may receive a request to allocate memory in memory region 400C, and, responsive to the request, host OS 108 may pin sub-region 406D. Sub-region 406D may match a size or a memory range indicated by the request to allocate memory in memory region 400C. Memory region 400E may be memory region 400D after host OS 108 pins sub-region 408. For example, host OS 108 may receive a request to allocate memory in memory region 400D, and, responsive to the request, host OS 108 may pin sub-region 408. Sub-region 408 may match a size or a memory range indicated by the request to allocate memory in memory region 400D. Each of sub-region 402E, sub-region 404E, sub-region 406E, and sub-region 408 may have been pinned responsive to individual requests to allocate memory.

FIG. 4B is a conceptual diagram illustrating techniques for pinning memory in host virtual memory via a fragmentation size, in accordance with one or more techniques of this disclosure. Memory regions 450 may represent a region of host virtual memory, e.g. first memory region 122. As shown in FIG. 4A, memory regions 450 may illustrate the region of host virtual memory after various memory operations. For example, memory region 450A may be a host virtual memory region before a memory operation, memory region 450B may be the host virtual memory region after a first operation, memory region 450C may be the host virtual memory region after a second operation, memory region 450D may be the host virtual memory region after a third operation, and memory region 450E may be the host virtual memory region after a fourth operation.

In FIG. 4B, host OS 108 may pin memory based on a fragmentation size. For example, when host OS 108 receives a request to allocate memory in a memory region, host OS 108 may pin a portion of memory equal to a size indicated by the request rounded up to a fragmentation size. Following requests to allocate memory in the memory region may result in host OS 108 allocating a portion of the already-pinned sub-region, if the sub-region includes memory that is pinned but not allocated (e.g., memory that is pinned but is not assigned to a guest VM or VMM 110).

As shown, memory region 450A includes only unpinned memory. For example, memory region 450A may include two MB of memory pages, where each page is in an unlocked state. Memory region 450B may be memory region 450A after host OS 108 pins sub-region 452B. For example, host OS 108 may receive a request to allocate memory in memory region 450A, and, responsive to the request, host OS 108 may pin sub-region 452B. Because memory region 450A had no pinned pages, sub-region 452B may match a size or a memory range indicated by the request to allocate memory in memory region 450A.

Memory region 450C may be memory region 450B after host OS 108 pins sub-region 454C. For example, host OS 108 may receive a request to allocate memory in memory region 450B, and, responsive to the request, host OS 108 may determine if memory region 450B includes a portion of pinned and unallocated memory sufficient to satisfy the request. Sub-region 452B may not include a sufficient amount of pinned and/or unallocated memory to satisfy the request. Therefore, host OS 108 may pin a new sub-region, sub-region 454C. Sub-region 454C may be equal to a size or memory range indicated by the request, rounded up to an amount divisible by a fragmentation size. For instance, if the request to allocate memory in memory region 450B indicates a four MB amount of memory, and the fragmentation size is three MB, sub-region 454C may include six MB of pinned memory, the six MB of pinned memory including four MB of allocated memory.

Memory region 450D may be memory region 450C after host OS 108 allocates additional memory from sub-region 454C. For example, host OS 108 may receive a request to allocate memory in memory region 450C, and, responsive to the request, host OS 108 may determine if memory region 450C includes a portion of pinned and unallocated memory sufficient to satisfy the request. Sub-region 454C includes a sufficient amount of pinned and unallocated memory to satisfy the request. Therefore, host OS 108 allocates memory from sub-region 454C to satisfy the request. For instance, if the request to allocate memory in memory region 450C indicates a one MB amount of memory, and sub-region 454C includes six MB of pinned memory and four MB of allocated memory, host OS 108 may allocate a one MB portion of sub-region 454C to satisfy the request. The resulting sub-region, sub-region 454D, may then include six MB of pinned memory, the six MB of pinned memory including five MB of allocated memory.

Memory region 450E may be memory region 450D after host OS 108 allocates additional memory from sub-region 454D. For example, host OS 108 may receive a request to allocate memory in memory region 450D, and, responsive to the request, host OS 108 may determine if memory region 450D includes a portion of pinned and unallocated memory sufficient to satisfy the request. Sub-region 454D includes a sufficient amount of pinned and unallocated memory to satisfy the request. Therefore, host OS 108 allocates memory from sub-region 454D to satisfy the request. For instance, if the request to allocate memory in memory region 450D indicates a one MB amount of memory, and sub-region 454D includes six MB of pinned memory and five MB of allocated memory, host OS 108 may allocate a one MB portion of sub-region 454D to satisfy the request. The resulting sub-region, sub-region 454E, may then include six MB of memory that is both allocated and pinned.

Additionally, or alternatively, VMM 110 may implement fragmentation techniques described with respect to FIG. 4B. In some implementations, VMM 110 may determine a size of a memory region by rounding an amount of memory specified by a VM up to an amount divisible by a fragmentation size. For example, VMM 110, implementing a fragmentation size of two MB, may receive a request for three MB of memory from a VM. In response, VMM 110 may request that host OS 108 pin and/or allocate a four MB memory region in a host virtual memory space. If VMM 110 later receives a request for one MB or less of memory from a VM, VMM 110 may allocate a sub-region of the four MB region to satisfy the request.

VMM 110 and/or host OS 108 may adjust the fragmentation size depending on memory utilization and availability. In some implementations, VMM 110 may reduce the fragmentation size in response to receiving a low-memory indication. For example, VMM 110, implementing a fragmentation size of two MB, may reduce the fragmentation size to 64 kilobytes (KB) in response to receiving an indication from host OS 108 that available virtual memory has dropped below a threshold.

A memory manager may use fragmentation techniques to dynamically change how much memory the manager pins in a region at any time, since regions are fully flexible and splittable. The memory manager may use the fragmentation techniques and other techniques of this disclosure to implement out of memory mitigations that are relevant to use cases e.g. gaming services, as games frequently run out of memory due to host OS resources constraints. For example, the memory manager may unpin memory that is currently pinned in any pattern, since the manager is able to service any unpin requests (regions may be split and/or merged to align with a user's requests).

Various techniques of this disclosure are directed to fragmentation size. For example, the fragmentation size may initially be two MB. When a guest VM of guest VMs 112 needs memory, host OS 108 may pin two MB at a time. The two MB fragmentation size may lead to over-pinning. For instance, a guest may only need four KB, despite the whole two MB being pinned around it. In over-pinning scenarios, host OS 108 and/or VMM may implement out of memory mitigation modes that dynamically relax pinning size. The fragmentation size may be reduced to, for example, one MB or 64 KB, thereby releasing memory back to host OS 108 so the memory may be paged out. Additionally, host OS 108 may unpin ahead of out-of-memory situations by unpinning memory if too much memory in host virtual memory is utilized.

Dynamic fragmentation alignment and proactive reaction to pressure enable a guest OS to better execute inside host OS 108. Significantly more memory is released back to host OS 108 than without these techniques and host OS 108 is better suited to survive low-memory situations. For example, host OS 108 may survive low-memory situations by unpinning memory that is pinned and lowering a fragmentation alignment to allow the guest to pin at a higher granularity and to free the unpinned memory for paging by host OS 108.

As discussed, various techniques of this disclosure are directed to splitting a host virtual memory region while the region remains pinned. These techniques may be implemented to provide an API as strong as a type 1 hypervisor (map and unmap any range of memory any time without stopping the guest VM) while using a type 2 hypervisor, using only kernel primitives of host OS 108. The techniques implement an MDL splitting technique, including allocating a desired region first and then unpinning an old region. If host OS 108 unpins the old region prior to allocating the new region(s), the guest OS may stop, and it is unsafe to unpin memory the guest OS is using. Using the MDL splitting technique, the guest may keep running while regions are unpinned, even if the regions were part of an actively used and pinned region. The region splits keep relevant pages pinned, meaning the VM does not need to stop during memory transactions.

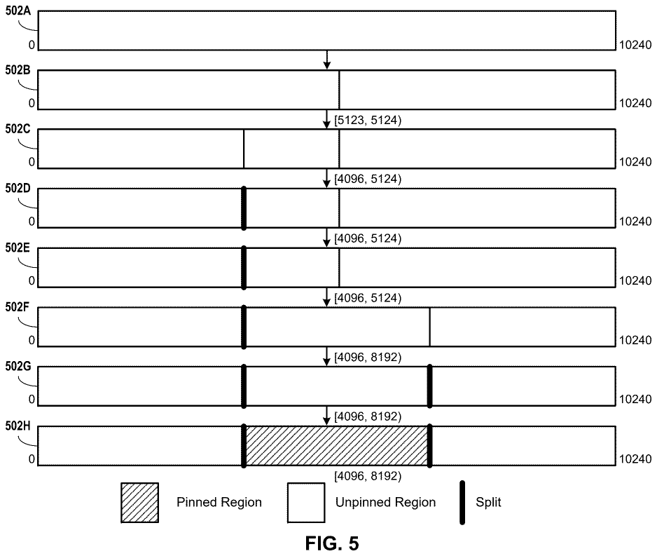

FIG. 5 is a conceptual diagram illustrating techniques for pinning memory in a first region state according to fragmentation alignment points, in accordance with one or more techniques of this disclosure. By implementing the fragmentation alignment points, host OS 108 avoids splitting a memory region into numerous small and fragmented memory regions after successive guest VM memory access requests. When host OS 108 receives a memory access request, host OS 108 may align the request to a common boundary, reducing split operations necessary for subsequent memory accesses.

As discussed, host OS 108 may split a region of host virtual memory 120 into two regions, the two regions mapped by an MDL and/or an accelerated structure of memory regions. If host OS 108 splits a pinned region of host virtual memory 120, host OS 108 may implement various techniques discussed with respect to FIG. 1 and FIG. 2 to ensure that the split memory region and the two new regions remain pinned throughout the splitting process. According to various aspects of the present disclosure, a “split” may refer to the beginning or ending address of a memory region that is mapped or is to be mapped by an MDL or accelerated structure of memory regions.

In some examples, host OS 108 implements a lazy allocation strategy for pinning memory addresses. For example, host OS 108 may allocate a portion of host virtual memory 120 (e.g., twelve MB of virtual memory) to guest VM 112A without pinning any region of host virtual memory 120. When guest VM 112A attempts to access an address of host virtual memory 120, host OS 108 pins the address and, in some implementations, the previous and/or subsequent address. Guest VM 112A may send many memory access requests to host OS 108 in order to access a memory region. For example, guest VM 112A may submit over a thousand memory access requests in order to access 1,024 concurrent pages of memory in a memory region of host virtual memory 120. Without fragmentation alignment, host OS 108 may split each individual accessed portion of memory into a separate region. These numerous split operations create significant work for components of host OS 108 (e.g., VMM 110).

As shown in FIG. 5, host virtual memory (e.g., host virtual memory 120) includes memory region 502A. Host OS 108 may record, via previous input/output control calls from a user space process, the regions of host virtual memory 120 that may be pinned to a guest VM. In the example illustrated with respect to FIG. 5, host OS 108 may record memory region 502A after receiving a memory state indication, the memory state indication allocating 10,240 addresses of host virtual memory 120 to a guest VM. Each address may refer to a unit of memory, such as a byte or page. For instance, memory regions 502 may be 10,240 bytes long. The 10,240 bytes may be separated into some number of pages depending on page size, e.g., memory regions 502 may include 10 pages, where each page includes 1,024 bytes. Other page sizes and memory region sizes are contemplated. For example, memory regions 502 may include 5 pages, where each page includes 4 KBs of memory. Memory region 502A may be allocated, but not pinned, to the guest VM in response to the memory state indication.

The guest VM may submit a memory access request to host OS 108 in order to access an address of memory region 502A. For instance, guest VM 112A may submit a memory access request for address 5123 in memory region 502A. As shown by memory region 502B, the guest VM is attempting to access address 5123.

In response to receiving the request to access address 5123, host OS 108 may round the received address down to a beginning fragmentation point based on a fragmentation size. For example, if the fragmentation size is 4,096, host OS 108 may round the received address down to the fragmentation point at address 4096, as shown by memory region 502C.

Host OS 108 may then determine whether the beginning fragmentation point overlaps a beginning address of memory region 502C. As shown by memory region 502C, the beginning fragmentation point (4096) does not overlap with the beginning address of memory region 502C (0). In response to determining that the beginning fragmentation point does not overlap the beginning address of memory region 502C, host OS 108 then splits memory region 502C into two sub-regions (e.g., two new memory regions) at address 4096, as shown by memory region 502D.

Host OS 108 may then determine whether to pin memory addresses in memory region 502D. In some implementations, host OS 108 may pin all unpinned regions between the beginning fragmentation point and a final sub-region between two splits and before the received address. As shown by memory region 502E, host OS 108 performs no action, since there is no sub-region after the beginning fragmentation point (4096) that is between two splits and has an ending address that is smaller than the received address (5123).

Host OS 108 may then round the received address up to an ending fragmentation point based on the fragmentation size. If the fragmentation size is 4,096, host OS 108 may round the received address, 5123, up to the fragmentation point at address 8192, as shown by memory region 502F.

Host OS 108 may then determine whether the ending fragmentation point overlaps an ending address of memory region 502F. As shown by memory region 502F, the ending fragmentation point (8192) does not overlap with the ending address of memory region 502F (10240). In response to determining that the ending fragmentation point does not overlap the ending address of memory region 502F, host OS 108 then splits memory region 502F into three sub-regions (e.g., two previous memory regions and a new memory region) at address 8192, as shown by memory region 502G.

After splitting memory region 502F, host OS 108 may pin the last region between the ending fragmentation point (8192) and the first split before the ending fragmentation point (the split at 4096). As shown by memory region 502H, host OS 108 may pin the memory region between addresses 4096 and 8192. According to various aspects of this disclosure, “between” may be inclusive or exclusive of both starting and ending points depending on implementation.

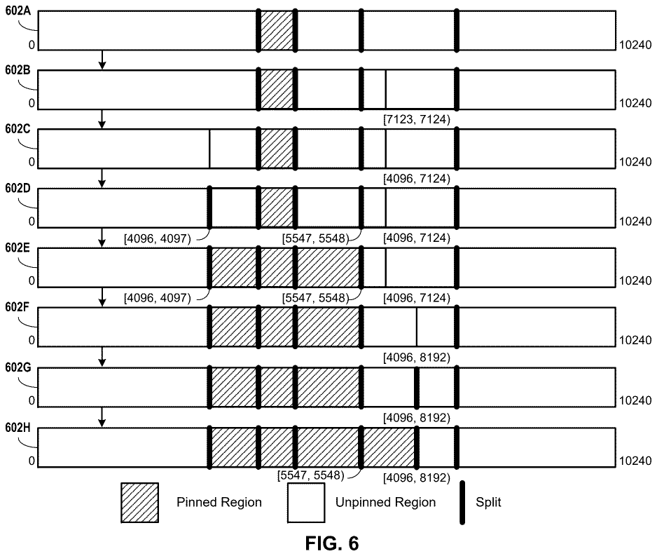

FIG. 6 is a conceptual diagram illustrating techniques for pinning memory in a second region state according to fragmentation alignment points, in accordance with one or more techniques of this disclosure. As with FIG. 5, the memory regions of FIG. 6 (memory regions 602) may represent a single memory region throughout a sequence of memory operations.

In the example of FIG. 6, memory region 602A includes various sub-regions, including a pinned sub-region, where each sub-region is separated from other sub-regions by a split. A technique for implementing fragmentation alignment may include receiving, by host OS 108, a request to access a memory address of a memory region. For example, host OS 108 may receive a pin request for address 7123, as shown by memory region 602B. The technique may also include determining, by host OS 108, a beginning fragmentation point by rounding the received memory address down to a memory address divisible by a fragmentation size. As shown by memory region 602C, host OS 108 may determine the beginning fragmentation point to be address 4096.

The technique for implementing fragmentation alignment may also include splitting, by host OS 108, the memory region at the beginning fragmentation point based on determining that the beginning fragmentation point does not match a beginning address of the memory region. For instance, host OS 108 may determine that the beginning fragmentation point of 4096 does not match the beginning address of 0 in memory region 602C. Therefore, host OS 108 may split memory region 602C at address 4096, as shown by memory region 602D.

The technique may further include pinning, by host OS 108, unpinned memory addresses between the beginning fragmentation point and a last split before the received memory address. As shown by memory region 602D, the last split before the received memory address is at address 5547. Three memory regions are between the beginning fragmentation point, address 4096, and address 5547. Host OS 108 may therefore pin any unpinned regions between addresses 4096 and 5547, as shown by memory region 602E.

The technique may additionally include determining, by host OS 108, an ending fragmentation point by rounding the received memory address up to a memory address divisible by the fragmentation size. As shown by memory region 602F, host OS 108 may round the received memory address, 7123, up to a memory address divisible by 4096 to determine the ending fragmentation point, 8192.

Performing the technique may also involve splitting, by host OS 108, the memory region at the ending fragmentation point based on determining that the ending fragmentation point does not match an ending address of the memory region. As shown by memory region 602F, the ending fragmentation point, 8192, does not match the ending fragmentation point of memory region 602F, 10240. Therefore, host OS 108 may split memory region 602F at address 8192, as shown by memory region 602G. The technique for implementing fragmentation alignment may also include pinning, by host OS 108, unpinned memory addresses between the received memory address and the ending fragmentation point. As shown by memory region 602H, host OS 108 may pin the memory region between addresses 5547 and 8192.

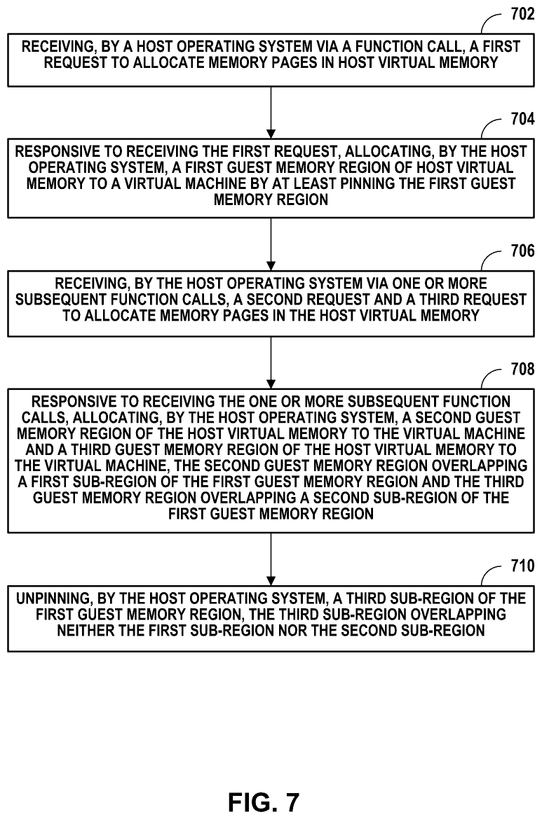

FIG. 7 is a flowchart illustrating an example operation for memory management by a host OS, in accordance with one or more techniques of this disclosure. FIG. 7 may be discussed with respect to FIG. 1 for example purposes only.

A technique for managing memory may include receiving, by a host OS via a function call, a first request to allocate memory pages in host virtual memory (702). For example, host OS 108 may receive a request to allocate a range of memory pages in host virtual memory 120 via a MmProbeAndLockPages function call (e.g., MmProbeAndLockPages of WINDOWS). The function call may have been initiated by VMM 110, where VMM 110 may be a type two hypervisor.

The technique may further include, responsive to receiving the first request, allocating, by the host OS, a first guest memory region of host virtual memory to a VM by at least pinning the first guest memory region (704). For instance, host OS 108 may pin first memory region 122 in host virtual memory 120. Furthermore, host OS 108 may allocate first memory region 122 by incrementing one or more reference counters associated with first memory region 122 and/or pages of first memory region 122, the incremented reference counter(s) indicating that first memory region 122 is locked and/or allocated to a guest VM of guest VMs 112 or to VMM 110.

The technique may also include receiving, by the host OS via one or more subsequent function calls, a second request and a third request to allocate memory pages in the host virtual memory (706). For example, host OS 108 may receive a second and a third MmProbeAndLockPages function call, where the second function call indicates second memory region 124 and the third function call indicates third memory region 126. Host OS 108 may receive the second and third function calls from VMM 110, VMM 110 providing the function calls based on memory usage of a guest VM and/or memory availability in host virtual memory 120.

The technique may additionally include, responsive to receiving the one or more subsequent function calls, allocating, by the host OS, a second guest memory region of the host virtual memory to the VM and a third guest memory region of the host virtual memory to the VM, the second guest memory region overlapping a first sub-region of the first guest memory region and the third guest memory region overlapping a second sub-region of the first guest memory region (708). For instance, host OS 108 may allocate second memory region 124 and third memory region 126 by incrementing one or more reference counters associated with the memory regions and/or pages of the memory regions. The reference counter(s) of second memory region 124 and third memory region 126 may have been twice-incremented, once regarding first memory region 122 and again regarding second memory region 124 and third memory region 126.

As shown with respect to FIG. 1, second memory region 124 overlaps a sub-region of first memory region 122. Further, third memory region 126 overlaps a sub-region of first memory region 122. In some implementations, the second guest memory region and/or the third guest memory region may overlap the first guest memory region while also extending outside of the first guest memory region. Furthermore, the second guest memory region and the third guest memory region may partially or fully overlap each other.

The technique may further include unpinning, by the host OS, a third sub-region of the first guest memory region, the third sub-region overlapping neither the first sub-region nor the second sub-region (710). For example, host OS 108 may receive a request to deallocate and/or unpin first memory region 122. In response, host OS 108 may decrement the reference counter(s) associated with first memory region 122. Pages inside of first memory region 122 but outside of second memory region 124 and third memory region 126 may now have reference counter values below an unpin threshold. Responsive to the reference counter values being below the unpin threshold, host OS 108 may unpin the associated pages.

Using the example technique for managing memory, second memory region 124 and third memory region 126 remain pinned and stable, while the remaining portion of first memory region 122 is freed for use by host OS 120. If host OS 108 had unpinned first memory region 122 prior to pinning second memory region 124 and third memory region 126, both second memory region 124 and third memory region 126 could potentially be subject to race conditions and/or swap conditions while unpinned, causing the guest VM to incur memory transaction errors.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium e.g. data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium e.g. a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies e.g. infrared, radio, and microwave, then the coaxial cable, fiber optic cable, twisted pair, DSL, or wireless technologies e.g. infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, e.g. one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of intraoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Example 1: A method includes receiving, by a host operating system via a function call, a first request to allocate memory pages in host virtual memory; responsive to receiving the first request, allocating, by the host operating system, a first guest memory region of host virtual memory to a virtual machine by at least pinning the first guest memory region; receiving, by the host operating system via one or more subsequent function calls, a second request and a third request to allocate memory pages in the host virtual memory; responsive to receiving the one or more subsequent function calls, allocating, by the host operating system, a second guest memory region of the host virtual memory to the virtual machine and a third guest memory region of the host virtual memory to the virtual machine, the second guest memory region overlapping a first sub-region of the first guest memory region and the third guest memory region overlapping a second sub-region of the first guest memory region; and unpinning, by the host operating system, a third sub-region of the first guest memory region, the third sub-region overlapping neither the first sub-region nor the second sub-region.

Example 2: The method of example 1, further including generating, by the host operating system, a memory descriptor list including a virtual address range and a physical address range corresponding to the virtual address range, wherein allocating the first guest memory region is based on the virtual address range; and transmitting, by the host operating system, the memory descriptor list to a virtual machine manager in response to receiving the function call.

Example 3: The method of any of examples 1 and 2, wherein the first request, second request, and third request are from a virtual machine manager, the virtual machine manager being a component of the host operating system but not a component of the virtual machine.

Example 4: The method of any of examples 1 through 3, further including determining, by a virtual machine manager, a size of the first guest memory region, the second guest memory region, or the third guest memory region by rounding an amount of memory specified by the virtual machine up to an amount divisible by a fragmentation size; and reducing, by the virtual machine manager, the fragmentation size in response to receiving a low-memory indication.

Example 5: The method of any of examples 1 through 4, further including: receiving, by the host operating system, a request to access a first memory address of a fourth memory region; determining, by the host operating system, a beginning fragmentation point by rounding the first memory address down to a second memory address divisible by a fragmentation size; splitting, by the host operating system, the fourth memory region at the beginning fragmentation point based on determining that the beginning fragmentation point does not match a beginning address of the fourth memory region; pinning, by the host operating system, unpinned memory addresses between the beginning fragmentation point and a last split before the first memory address; determining, by the host operating system, an ending fragmentation point by rounding the first memory address up to a third memory address divisible by the fragmentation size; splitting, by the host operating system, the fourth memory region at the ending fragmentation point based on determining that the ending fragmentation point does not match an ending address of the fourth memory region; and pinning, by the host operating system, unpinned memory addresses between the first memory address and the ending fragmentation point.

Example 6: The method of any of examples 1 through 5, further including generating, by a virtual machine manager, an accelerated structure of memory regions, the accelerated structure being a tree, skip list, or linked list and including one or more addresses of a set of guest memory regions in the host virtual memory; and determining, by the virtual machine manager, a guest memory region location based on the accelerated structure of memory regions.

Example 7: The method of any of examples 1 through 6, further including, after receiving the second request and the third request, receiving, by the host operating system, a fourth request, the fourth request being to deallocate the first guest memory region, wherein unpinning the third sub-region is in response to receiving the fourth request.

Example 8: A computing system includes one or more processors; and one or more storage devices storing instructions that, when executed by the one or more processors, cause the one or more processors to: receive, via a function call, a first request to allocate memory pages in host virtual memory; responsive to receiving the first request, allocate a first guest memory region of host virtual memory to a virtual machine by at least pinning the first guest memory region; receive, via one or more subsequent function calls, a second request and a third request to allocate memory pages in the host virtual memory; responsive to receiving the one or more subsequent function calls, allocate a second guest memory region of the host virtual memory to the virtual machine and a third guest memory region of the host virtual memory to the virtual machine, the second guest memory region overlapping a first sub-region of the first guest memory region and the third guest memory region overlapping a second sub-region of the first guest memory region; and unpin a third sub-region of the first guest memory region, the third sub-region overlapping neither the first sub-region nor the second sub-region.

Example 9: The computing system of example 8, wherein the instructions further cause the one or more processors to: generate a memory descriptor list including a virtual address range and a physical address range corresponding to the virtual address range, wherein allocating the first guest memory region is based on the virtual address range; and transmit the memory descriptor list to a virtual machine manager in response to receiving the function call.

Example 10: The computing system of any of examples 8 and 9, wherein the first request, second request, and third request are from a virtual machine manager, the virtual machine manager being a component of a host operating system but not a component of the virtual machine.

Example 11: The computing system of any of examples 8 through 10, wherein the instructions further cause the one or more processors to determine a size of the first guest memory region, the second guest memory region, or the third guest memory region by rounding an amount of memory specified by the virtual machine up to an amount divisible by a fragmentation size; and reduce the fragmentation size in response to receiving a low-memory indication.

Example 12: The computing system of any of examples 8 through 11, wherein the instructions further cause the one or more processors to: receive a request to access a first memory address of a fourth memory region; determine a beginning fragmentation point by rounding the first memory address down to a second memory address divisible by a fragmentation size; split the fourth memory region at the beginning fragmentation point based on determining that the beginning fragmentation point does not match a beginning address of the fourth memory region; pin unpinned memory addresses between the beginning fragmentation point and a last split before the first memory address; determine an ending fragmentation point by rounding the first memory address up to a third memory address divisible by the fragmentation size; split the fourth memory region at the ending fragmentation point based on determining that the ending fragmentation point does not match an ending address of the fourth memory region; and pin unpinned memory addresses between the first memory address and the ending fragmentation point..

Example 13: The computing system of any of examples 8 through 12, wherein the instructions further cause the one or more processors to: generate an accelerated structure of memory regions, the accelerated structure being a tree, skip list, or linked list and including one or more addresses of a set of guest memory regions in the host virtual memory; and determine a guest memory region location based on the accelerated structure of memory regions.

Example 14: The computing system of any of examples 8 through 13, wherein the instructions further cause the one or more processors to, after receiving the second request and the third request, receive a fourth request, the fourth request being to deallocate the first guest memory region, wherein unpinning the third sub-region is in response to receiving the fourth request.

Example 15: A non-transitory computer-readable storage medium comprising instructions, that when executed by one or more processors of a computing system, cause the one or more processors to: receive, via a function call, a first request to allocate memory pages in host virtual memory; responsive to receiving the first request, allocate a first guest memory region of host virtual memory to a virtual machine by at least pinning the first guest memory region; receive, via one or more subsequent function calls, a second request and a third request to allocate memory pages in the host virtual memory; responsive to receiving the one or more subsequent function calls, allocate a second guest memory region of the host virtual memory to the virtual machine and a third guest memory region of the host virtual memory to the virtual machine, the second guest memory region overlapping a first sub-region of the first guest memory region and the third guest memory region overlapping a second sub-region of the first guest memory region; and unpin a third sub-region of the first guest memory region, the third sub-region overlapping neither the first sub-region nor the second sub-region.

Example 16: The non-transitory computer-readable storage medium of example 15, wherein the one or more processors further execute the instructions to: generate a memory descriptor list including a virtual address range and a physical address range corresponding to the virtual address range, wherein allocating the first guest memory region is based on the virtual address range; and transmit the memory descriptor list to a virtual machine manager in response to receiving the function call.

Example 17: The non-transitory computer-readable storage medium of any of examples 15 and 16, wherein the first request, second request, and third request are from a virtual machine manager, the virtual machine manager being a component of a host operating system but not a component of the virtual machine.

Example 18: The non-transitory computer-readable storage medium of any of examples 15 through 17, wherein the one or more processors further execute the instructions to determine a size of the first guest memory region, the second guest memory region, or the third guest memory region by rounding an amount of memory specified by the virtual machine up to an amount divisible by a fragmentation size.

Example 19: The non-transitory computer-readable storage medium of any of examples 15 through 18, wherein the one or more processors further execute the instructions to reduce the fragmentation size in response to receiving a low-memory indication.

Example 20: The non-transitory computer-readable storage medium of any of examples 15 through 19, wherein the one or more processors further execute the instructions to: generate an accelerated structure of memory regions, the accelerated structure being a tree, skip list, or linked list and including one or more addresses of a set of guest memory regions in the host virtual memory; and determine a guest memory region location based on the accelerated structure of memory regions.

Example 21: The non-transitory computer-readable storage medium of any of examples 15 through 20, wherein the one or more processors further execute the instructions to, after receiving the second request and the third request, receive a fourth request, the fourth request being to deallocate the first guest memory region, wherein unpinning the third sub-region is in response to receiving the fourth request.

Example 22: A computing system comprising means for performing any combination of examples 1 through 7.

Example 23: A computer program product comprising one or more instructions that, when executed by a computing device, cause the computing device to perform any combination of examples 1 through 7.

What is claimed is:

1. A method comprising:
receiving, by a host operating system via a function call, a first request to allocate memory pages in host virtual memory;
responsive to receiving the first request, allocating, by the host operating system, a first guest memory region of host virtual memory to a virtual machine by at least pinning the first guest memory region;
receiving, by the host operating system via one or more subsequent function calls, a second request and a third request to allocate memory pages in the host virtual memory;
responsive to receiving the one or more subsequent function calls, allocating, by the host operating system, a second guest memory region of the host virtual memory to the virtual machine and a third guest memory region of the host virtual memory to the virtual machine, the second guest memory region overlapping a first sub-region of the first guest memory region and the third guest memory region overlapping a second sub-region of the first guest memory region; and
unpinning, by the host operating system, a third sub-region of the first guest memory region, the third sub-region overlapping neither the first sub-region nor the second sub-region.

2. The method of claim 1, further comprising:
generating, by the host operating system, a memory descriptor list including a virtual address range and a physical address range corresponding to the virtual address range, wherein allocating the first guest memory region is based on the virtual address range; and
transmitting, by the host operating system, the memory descriptor list to a virtual machine manager in response to receiving the function call.

3. The method of claim 1, wherein the first request, second request, and third request are from a virtual machine manager, the virtual machine manager being a component of the host operating system but not a component of the virtual machine.

4. The method of claim 1, further comprising:
determining, by a virtual machine manager, a size of the first guest memory region, the second guest memory region, or the third guest memory region by rounding an amount of memory specified by the virtual machine up to an amount divisible by a fragmentation size
reducing, by the virtual machine manager, the fragmentation size in response to receiving a low-memory indication.

5. The method of claim 1, further comprising:
receiving, by the host operating system, a request to access a first memory address of a fourth memory region;
determining, by the host operating system, a beginning fragmentation point by rounding the first memory address down to a second memory address divisible by a fragmentation size;
splitting, by the host operating system, the fourth memory region at the beginning fragmentation point based on determining that the beginning fragmentation point does not match a beginning address of the fourth memory region;
pinning, by the host operating system, unpinned memory addresses between the beginning fragmentation point and a last split before the first memory address;
determining, by the host operating system, an ending fragmentation point by rounding the first memory address up to a third memory address divisible by the fragmentation size;
splitting, by the host operating system, the fourth memory region at the ending fragmentation point based on determining that the ending fragmentation point does not match an ending address of the fourth memory region; and
pinning, by the host operating system, unpinned memory addresses between the first memory address and the ending fragmentation point.

6. The method of claim 1, further comprising:
generating, by a virtual machine manager, an accelerated structure of memory regions, the accelerated structure being a tree, skip list, or linked list and including one or more addresses of a set of guest memory regions in the host virtual memory; and
determining, by the virtual machine manager, a guest memory region location based on the accelerated structure of memory regions.

7. The method of claim 1, further comprising:
after receiving the second request and the third request, receiving, by the host operating system, a fourth request, the fourth request being to deallocate the first guest memory region, wherein unpinning the third sub-region is in response to receiving the fourth request.

8. A computing system comprising:
one or more processors; and
one or more storage devices storing instructions that, when executed by the one or more processors, cause the one or more processors to:
receive, via a function call, a first request to allocate memory pages in host virtual memory;
responsive to receiving the first request, allocate a first guest memory region of host virtual memory to a virtual machine by at least pinning the first guest memory region;
receive, via one or more subsequent function calls, a second request and a third request to allocate memory pages in the host virtual memory;
responsive to receiving the one or more subsequent function calls, allocate a second guest memory region of the host virtual memory to the virtual machine and a third guest memory region of the host virtual memory to the virtual machine, the second guest memory region overlapping a first sub-region of the first guest memory region and the third guest memory region overlapping a second sub-region of the first guest memory region; and
unpin a third sub-region of the first guest memory region, the third sub-region overlapping neither the first sub-region nor the second sub-region.

9. The computing system of claim 8, wherein the instructions further cause the one or more processors to:
generate a memory descriptor list including a virtual address range and a physical address range corresponding to the virtual address range, wherein allocating the first guest memory region is based on the virtual address range; and
transmit the memory descriptor list to a virtual machine manager in response to receiving the function call.

10. The computing system of claim 8, wherein the first request, second request, and third request are from a virtual machine manager, the virtual machine manager being a component of a host operating system but not a component of the virtual machine.

11. The computing system of claim 8, wherein the instructions further cause the one or more processors to:
determine a size of the first guest memory region, the second guest memory region, or the third guest memory region by rounding an amount of memory specified by the virtual machine up to an amount divisible by a fragmentation size; and
reduce the fragmentation size in response to receiving a low-memory indication.

12. The computing system of claim 8, wherein the instructions further cause the one or more processors to:
receive a request to access a first memory address of a fourth memory region;
determine a beginning fragmentation point by rounding the first memory address down to a second memory address divisible by a fragmentation size;
split the fourth memory region at the beginning fragmentation point based on determining that the beginning fragmentation point does not match a beginning address of the fourth memory region;
pin unpinned memory addresses between the beginning fragmentation point and a last split before the first memory address;
determine an ending fragmentation point by rounding the first memory address up to a third memory address divisible by the fragmentation size;
split the fourth memory region at the ending fragmentation point based on determining that the ending fragmentation point does not match an ending address of the fourth memory region; and
pin unpinned memory addresses between the first memory address and the ending fragmentation point.

13. The computing system of claim 8, wherein the instructions further cause the one or more processors to:
generate an accelerated structure of memory regions, the accelerated structure being a tree, skip list, or linked list and including one or more addresses of a set of guest memory regions in the host virtual memory; and
determine a guest memory region location based on the accelerated structure of memory regions.

14. The computing system of claim 8, wherein the instructions further cause the one or more processors to, after receiving the second request and the third request, receive a fourth request, the fourth request being to deallocate the first guest memory region, wherein unpinning the third sub-region is in response to receiving the fourth request.

15. A non-transitory computer-readable storage medium comprising instructions, that when executed by one or more processors of a computing system, cause the one or more processors to:
receive, via a function call, a first request to allocate memory pages in host virtual memory;
responsive to receiving the first request, allocate a first guest memory region of host virtual memory to a virtual machine by at least pinning the first guest memory region;
receive, via one or more subsequent function calls, a second request and a third request to allocate memory pages in the host virtual memory;
responsive to receiving the one or more subsequent function calls, allocate a second guest memory region of the host virtual memory to the virtual machine and a third guest memory region of the host virtual memory to the virtual machine, the second guest memory region overlapping a first sub-region of the first guest memory region and the third guest memory region overlapping a second sub-region of the first guest memory region; and
unpin a third sub-region of the first guest memory region, the third sub-region overlapping neither the first sub-region nor the second sub-region.

16. The non-transitory computer-readable storage medium of claim 15, wherein the one or more processors further execute the instructions to:
generate a memory descriptor list including a virtual address range and a physical address range corresponding to the virtual address range, wherein allocating the first guest memory region is based on the virtual address range; and
transmit the memory descriptor list to a virtual machine manager in response to receiving the function call.

17. The non-transitory computer-readable storage medium of claim 15, wherein the first request, second request, and third request are from a virtual machine manager, the virtual machine manager being a component of a host operating system but not a component of the virtual machine.

18. The non-transitory computer-readable storage medium of claim 15, wherein the one or more processors further execute the instructions to:
determine a size of the first guest memory region, the second guest memory region, or the third guest memory region by rounding an amount of memory specified by the virtual machine up to an amount divisible by a fragmentation size; and
reduce the fragmentation size in response to receiving a low-memory indication.

19. The non-transitory computer-readable storage medium of claim 15, wherein the one or more processors further execute the instructions to:
generate an accelerated structure of memory regions, the accelerated structure being a tree, skip list, or linked list and including one or more addresses of a set of guest memory regions in the host virtual memory; and
determine a guest memory region location based on the accelerated structure of memory regions.

20. The non-transitory computer-readable storage medium of claim 15, wherein the one or more processors further execute the instructions to, after receiving the second request and the third request, receive a fourth request, the fourth request being to deallocate the first guest memory region, wherein unpinning the third sub-region is in response to receiving the fourth request.
